(19) United States
(12) Patent Application Publication
(10) Pub. No.: US 2010/0089811 A1
(43) Pub. Date: Apr. 15, 2010

(54) HPLC preparative column design

(76) Inventors: Yury Zelechonok, Northbrook, IL (US); Vladislav Orlovsky, Wheeling, IL (US)

Correspondence Address: Charles F. Lind, 2210 East Sherwood, Arlington Hts., IL, 60004, US

(21) Appl. No.: 12/287,652

(22) Filed: Oct. 14, 2008

(51) Int. Cl. B01D 15/10

(52) U.S. Cl. 210/198.3

(57) ABSTRACT

The preparative column has an inner thin wall HPLC compatible material tube, packed with absorbent particles, with filters and end fittings of HPLC compatible material at the tube ends. An aluminum outer sleeve tightly overlies and reinforces the inner tube, aluminum end caps overlie the end fittings and are secured to the outer sleeve. End connections in the end fittings allow solvent and sample flow through the packed absorbent. Exterior axial flats on the aluminum sleeve and end caps provide broad contact against flat thermal surfaces of conventional temperature controllers, thereby yielding effective thermal transfer there between. The flats further minimize column rolling on flat level surfaces and provide favorable locations for connection taps for conveying coolant flow through passages formed in the sleeve.

### FIELD OF THE INVENTION

This invention relates to the high performance liquid chromatography technology (herein referred to as HPLC), and more specifically to the preparative column used therein.

### BACKGROUND OF THE INVENTION

HPLC technology is widely used to detect and identify different components contained in a test sample. Typical HPLC instruments use a high pressure pump for forcing a suitable solvent, via capillary lines, at a constant flow rate serially through a separation column, and a UV or other type detector. The column contains an absorbent selected for components anticipated to be in the test samples. During a run, a small quantity of the test sample injected into the flow of the pressurized solvent will travel into and through the separation column. The different sub phase sample components pass through the column at different rates, each thereby becoming substantially isolated before passing the detector for individual identification.

Different separation columns are commercially available for achieving various testing needs, being of different lengths and/or diameters, and/or contained absorbent. The columns are fabricated primarily of HPLC compatible materials, such as stainless steel, titanium, or some advanced plastics, to chemically withstand the contained liquid solvent and physically provide containment of the high solvent pressures.

Preparative chromatography is used to isolate and collect a component or components of interest in a sample passed through the preparative column.

Of relevance to this invention, the preparative column bore diameter is typically between 0.5 and 12 inches, thereby requiring walls that are quite thick compared to the walls of analytical HPLC columns having bore diameters less than 0.5 inch. The larger preparative columns can be quite costly due to both the significant quantity and cost of the HPLC compatible materials needed to make them.

A further problem experienced when using existing preparative columns is the inability to hold the operating temperatures within a specific range. One reason for this is that the tubular column typically has bulky ends that reduce effective thermal transfer column contact with flat surfaces of conventional heating/cooling apparatus. Another reason is that the column body is fabricated primarily of HPLC compatible materials having poor thermal conductivity, further reducing effective thermal transfer with the conveyed liquid.

### OBJECTS, FEATURES AND SUMMARY OF THE INVENTION

A basic object of this invention is to provide an HPLC preparative column design that is fabricated using less HPLC compatible materials, than a comparable prior art preparative column, so as to reduce the column costs, particularly for large columns.

Another object of this invention is to provide an HPLC preparative column design having improved heat transfer characteristics for accurate temperature control.

The inventive HPLC preparative column design has a thermally conductive outer sleeve (such as of aluminum) tightly overlying a thin wall inner tube formed of the needed HPLC compatible material. The dual outer sleeve-inner tube design provides additive containment of the high column pressures, with less HPLC compatible material than comparable prior art designs. The highly conductive outer aluminum sleeve improves temperature control of fluid passing through the column. Flats on the column exterior can be positioned on flat temperature controlled faces of conventional heating/cooling apparatus, for improving temperature control of the separation process and for minimizing column rolling on all flat level surfaces.

### BRIEF DESCRIPTION OF THE DRAWINGS

These and other objects, features or advantages of the invention will be more fully understood and appreciated after considering the following disclosure of the invention, which includes the accompanying drawings, wherein:

FIG. 1 is a centered sectional view of the improved HPLC preparative column, showing also preparative column end taps for securing capillary lines (not shown) for conveying the solvent and test samples;

FIG. 2 is a perspective view of the preassembled inner tube and outer sleeve components used in the column;

FIG. 3 is a perspective view of the FIG. 2 components assembled, including coolant taps thereon, and showing also in an exploded association column end closure components; and

FIG. 4 is a sectional view of the preparative column, as seen from sight lines rotated compared to FIG. 1, showing an operative system for heating or cooling the column.

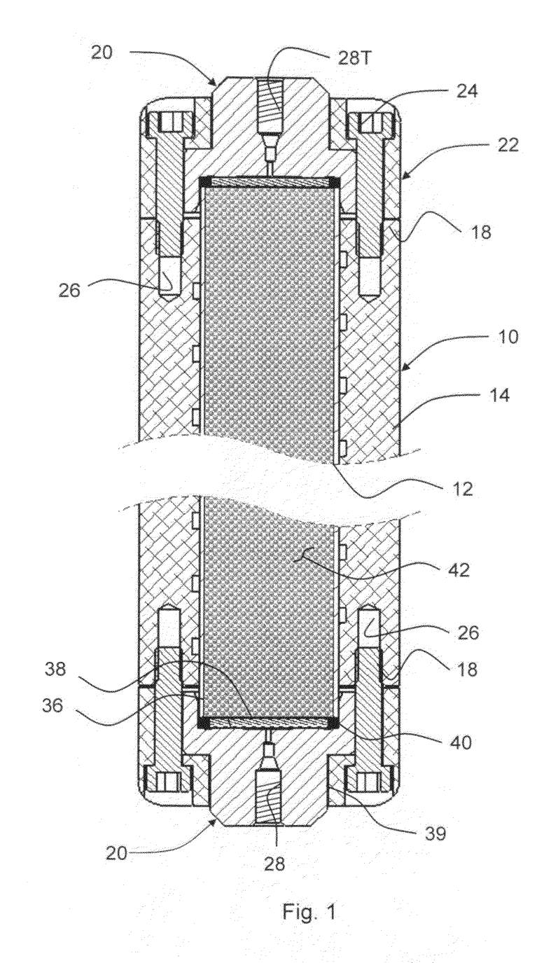

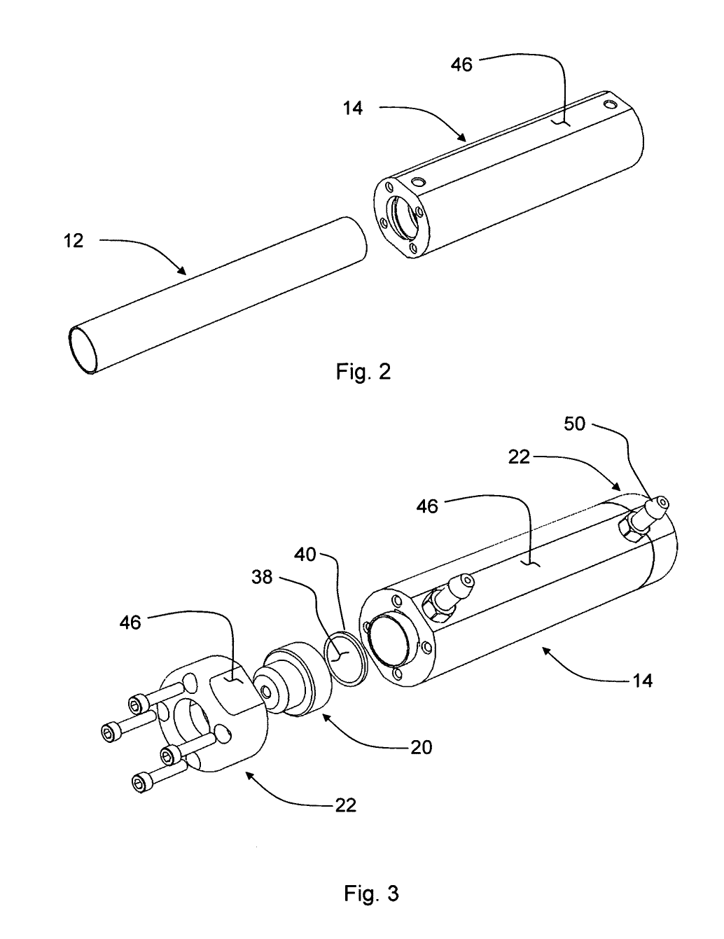

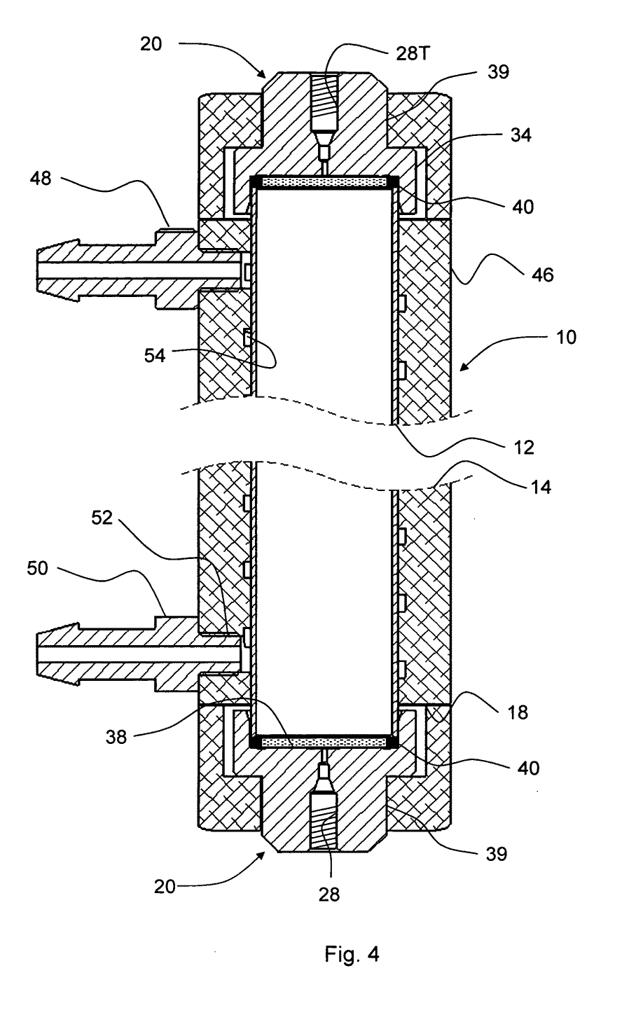

### DETAILED DESCRIPTION OF THE INVENTION

The inventive HPLC preparative column 10 has an inner thin wall HPLC compatible material tube 12 that is press-fit into an overlying outer tube or sleeve 14 of aluminum. The inner tube 12 might be slightly longer than the outer sleeve 14, by possibly ¼″ or so, so that its ends 16 protrude slightly (and generally equally) beyond the adjacent end faces 18 of the outer sleeve 14.

Annular end fittings 20 are positioned outwardly adjacent the inner tube 12, annular end caps 22 overlie the end fittings, and bolts 24 threaded into taps 26 in the outer sleeve 14 hold these components assembled together.

Each end fitting 20 has a through bore 28 with a threaded tap 28T at its outer end, suited to receive a connector for holding a capillary line (neither being shown) that can be used to connect the preparative column 10 in an HPLC instrument (not shown). Each end fitting 20 also has an annular wall 34 terminating at cross wall 36, defining thereby an open cavity sized to fit snuggly over protruding end 16 of the inner tube 12.

A sintered stainless steel disc filter 38, having a peripheral sealing member 40, fits in the end fitting cavity to butt against the wall 36 and lie then across the end fitting flow passage 28. Each end fitting 20 further projects as a narrowed cylinder 39 from the back side of the cross wall 36, with the passage 28 being extended through the cylinder. When the end fitting 20 and outer sleeve are clamped together, a liquid-tight seal is established across seal 40 between the inner tube 12 and end fitting 20.

The inner tube 12 has a through bore of uniform diameter from end to end, with highly polished inner surfaces, which bore is filled with a granular absorbent 42.

As the sealing members 40 will provide effective and resilient sealing of the inner tube 12 and end fitting 20, the end fitting 20 need not be bottomed solid against the outer tube when tightening the end cap bolts 24.

During the column use, a solvent having a test sample carried therein would be pumped via capillary lines (not shown) connected to the threaded end fitting flow passages 28T under high pressures (up to 5,000 psi) for flow through the absorbent particles 42 tightly packed in the column inner tube 12.

Of importance to this invention, the maximum outer surfaces of the aluminum sleeve and end caps can be substantially cylindrical end to end, and of the same size. However, it is preferred that at least one and preferably two opposed axially extended flats 46 be provided on the outer surfaces of the connected sleeve and end caps.

The flats 46 serve to fit flush against a flat thermal controller surface (not shown), for greatly increasing the surface contact and the effective heat transfer between the conveyed liquid solvent and sample in the column and the thermal controller surface. Moreover, the engaged column flats would stably support the tubular column and prevent it from rolling on the thermal controller surface or any other flat surface.

Cooling inlet and outlet fittings 48, 50 can be threaded into taps 52 provided along one of the flats 46, which taps could be interconnected via internal helical passages 54 cut along the inside face of the outer sleeve 14. Coolant lines (not shown) could be connected to the fittings 48, 50 for passing a liquid coolant (such as water) axially through the column via the passages 54, for most effective thermal heat transfer to the inner tube 12 along its entire length and periphery.

However in place of the helical groove 54, one or more simple axial bores (not shown) could be extended between spaced inlet and outlet taps 52 proximate the ends of the highly conductive outer sleeve of aluminum, which again could provide axial flow paths for temperature control (heating or cooling) of the column.

The improved HPLC preparative column design can be provided with different bore diameters, lengths and absorbents, and can be operated with conventional HPLC instruments.

In describing this invention, the term “thin wall” inner tube means that the inner tube by itself is incapable of withstanding and containing the high pressures that the HPLC column would typically contain. However, the outer sleeve closely fitted over the inner tube operates additively with the inter tube, for withstanding these high operating pressures. The inner tube 12 and end fittings 20 would be formed of HPLC compatible material as noted. The filter 38 preferably would be as a mesh or sintered micro-sized particles. The outer tube 14 would be formed of aluminum, which has very good heat conductivity, is durable, lightweight and easily machined to size and shape, and is comparatively economical versus the HPLC compatible materials.

While a single embodiment has been illustrated, minor changes could be made without departing from the inventive teaching. Accordingly, the invention is to be limited only by the following claims.

What is claimed is:

1. A preparative column comprising
an inner HPLC compatible thin wall tube having absorbent particles packed in its through bore;
a pair of HPLC compatible end fittings closing opposite ends of the inner tube bore;
each end fitting having a through bore communicating at one end with the tube bore and having a tap at its opposite end suited for making a flow connection for a pumped HPLC solvent having a test sample therein;
an aluminum sleeve tightly overlying and structurally reinforcing the inner tube; and
means for retaining the end fittings seated against the inner tube.

2. A HPLC preparative column according to claim 1, further comprising said inner tube being longer than the outer sleeve so as to have opposite ends that protrude beyond end faces on the outer sleeve, and each end fitting having wall structure defining an open cavity sized to fit closely over a respective protruding inner tube end.

3. A HPLC preparative column according to claim 2, further comprising a HPLC compatible filter positioned in each end fitting cavity, operable to lie across the flow passage with one side of each filter against the absorbent particles.

4. A HPLC preparative column according to claim 1, further comprising a coolant passage through the outer sleeve, and taps to the passage ends operable for connecting coolant for flow through and temperature control of the column.

5. A HPLC preparative column according to claim 1, further comprising an axially extended flat formed on the outer sleeve operable to fit flush against a flat thermal controller surface for offering effective temperature control and preventing column rolling on the surface.

6. A HPLC preparative column according to claim 5, further comprising a coolant passage in the outer sleeve, and taps to the passage operable for connecting coolant flow through and temperature control of the column.

7. A HPLC preparative column according to claim 6, further comprising said inner tube being longer than the outer tube so as to have opposite ends that protrude beyond end faces on the outer tube, and the end fittings each having wall structure defining an open cavity sized to fit closely over a respective protruding inner tube end.

8. A HPLC preparative column according to claim 7, further comprising a HPLC compatible filter positioned in each end fitting cavity, operable to lie across the flow passage with one side of each filter against the absorbent particles packed in the inner tube.
